(19) United States
(12) Patent Application Publication
(10) Pub. No.: US 2013/0011710 A1
(43) Pub. Date: Jan. 10, 2013

(54) BATTERY PACK

(76) Inventors: Keisuke Naito, Osaka (JP); Masatoshi Nagayama, Osaka (JP)

(21) Appl. No.: 13/580,049

(22) PCT Filed: Dec. 22, 2011
(86) PCT No.: PCT/JP11/07210

§ 371 Date: Aug. 20, 2012

(30) Foreign Application Priority Data
Jan. 7, 2011 (JP) 2011-001747

(51) Int. Cl. H01M 2/20; H01M 2/10

(52) U.S. Cl. 429/99

(57) ABSTRACT

A battery pack of the present invention includes a plurality of battery blocks 6 in each of which a plurality of cells 1 are accommodated and which are arranged adjacent to each other in a first direction with a predetermined space S; and a flat plate shaped bus bar 7 arranged so as to contact first surfaces s1 of adjacent ones of the battery blocks 6 and electrically connecting adjacent ones of the battery blocks 6 together. At least one opening O communicating with the space S is formed in the bus bar 7. The bus bar 7 includes at least one first raised part 8 protruding toward the space S. The first raised part 8 contacts second surfaces s2 of adjacent ones of the battery blocks 6 exposed in the space S.

### TECHNICAL FIELD

The present invention relates to a battery pack including a bus bar electrically connecting adjacent ones of battery blocks together.

### BACKGROUND ART

In recent years, a battery pack (assembled cells) using many cells has been used as a power source for mobiles such as motor-assisted bicycles, pure electric vehicles (PEV), or hybrid electric vehicles (HEV).

As a battery pack in which cells can be cooled, e.g., a battery pack described in Patent Document 1 has been proposed. The battery pack described in Patent Document 1 will be described with reference to FIGS. 20, 21, 22(a), and 22(b). FIG. 20 is a perspective view illustrating a configuration of the battery pack described in Patent Document 1. FIG. 21 is a perspective view illustrating a configuration of a unit battery block provided in the battery pack described in Patent Document 1. FIGS. 22(a) and 22(b) are plan views illustrating a configuration of holder members forming a battery holder provided in the unit battery block.

As illustrated in FIG. 20, the battery pack described in Patent Document 1 includes a plurality of unit battery blocks 101 (three unit battery blocks 101) arranged in a first direction.

As illustrated in FIG. 21, the unit battery block 101 includes a plurality of cells 102 (sixteen cells) and a battery holder 103 for holding the plurality of cells 102. The battery holder 103 is formed by a pair of holder members 103x and 103y. One end of a row including a group of a plurality of cells 102 (four cells 102) arranged in a second direction is fixed to the holder member 103x, and the other end of the row including the group of the cells 102 is fixed to the holder member 103y. Note that, as illustrated in FIG. 21, the second direction is a direction perpendicular to the first direction.

As illustrated in FIG. 22(a), a recess 105x is formed along a joint plane 104x of the holder member 103x at which the holder member 103x is jointed to another holder member 103x. Similarly, as illustrated in FIG. 22(b), a recess 105y is formed along a joint plane 104y of the holder member 103y at which the holder member 103y is jointed to another holder member 103y. Thus, as illustrated in FIG. 20, an air vent path 106 into which cold air is introduced is formed between adjacent ones of the unit battery blocks 101 arranged in the first direction. In the battery pack described in Patent Document 1, cold air introduced into the air vent paths 106 is supplied to the cells 102, thereby cooling the cells 102.

### CITATION LIST

### Patent Document

PATENT DOCUMENT 1: Japanese Patent Publication No. 2007-328927

### SUMMARY OF THE INVENTION

### Technical Problem

Study has been conducted by the present applicant to provide the following battery pack as the battery pack in which the cells can be cooled. Such a battery pack will be described with reference to FIG. 19. FIG. 19 is a perspective view illustrating a configuration of the battery pack.

As illustrated in FIG. 19, the battery pack proposed by the present applicant includes a plurality of battery blocks 201 each including a plurality of cells and arranged adjacent to each other in a first direction with a predetermined space S, and a flat plate shaped bus bar 202 electrically connecting the adjacent battery blocks 201 together. An opening O communicating with the space S is formed in the bus bar 202. The opening O and the space S form a flow path through which cold air flows. The cells accommodated in the adjacent battery blocks 201 are cooled by cold air flowing through the flow path.

However, the following disadvantages are caused in the battery pack proposed by the present applicant.

Current flows from one of the adjacent battery blocks 201 to the other battery block 201 through the bus bar 202.

The current flows around the opening O of the bus bar 202. Thus, there is a disadvantage that the current is concentrated on regions (hereinafter referred to as “current concentration regions R”) of the bus bar 202 at the sides of the opening O in a second direction. As a result, since electric resistance in each of the current concentration regions R is increased due to the current concentration, a voltage drop occurs in each of the current concentration regions R. In addition, heat is generated in each of the current concentration regions R due to the current concentration. Note that, as illustrated in FIG. 19, the second direction is a direction perpendicular to the first direction. The “voltage drop” is a phenomenon that produce a potential difference between both ends of a resistor (phenomenon that voltage drops when current flows through the resistor).

The strength of a region (hereinafter referred to as a “low strength region”) of the bus bar 202 around the opening O is reduced. Thus, there is another disadvantage that, when the battery block 201 receives, e.g., impact force, the bus bar 202 is bent or cut at the region of the bus bar 202 around the opening O (i.e., at the low strength region).

In the view of the foregoing, it is an objective of the present invention to, in a battery pack including a bus bar electrically connecting adjacent ones of battery blocks together, prevent current concentration on a particular region of the bus bar and prevent bending or cutting of the bus bar.

### Solution to the Problem

In order to accomplish the foregoing objective, a battery pack of the present invention includes a plurality of battery blocks in each of which a plurality of cells are accommodated and which are arranged adjacent to each other in a first direction with a predetermined space; and a flat plate shaped bus bar arranged so as to contact first surfaces of adjacent ones of the battery blocks and electrically connecting adjacent ones of the battery blocks together. At least one opening communicating with the space is formed in the bus bar. The bus bar includes at least one first raised part protruding toward the space. The first raised part contacts second surfaces of adjacent ones of the battery blocks exposed in the space.

In the battery pack of the present invention, the first raised part is preferably positioned at at least one end of the opening in a second direction perpendicular to the first direction.

### Advantages of the Invention

According to the battery pack of the present invention, current concentration on a particular region (specifically a region of the bus bar at the side of the opening in the second direction) of the bus bar can be prevented. In addition, bending or cutting of the bus bar in a region of the bus bar around the opening can be prevented.

### BRIEF DESCRIPTION OF THE DRAWINGS

FIG. 1 is a cross-sectional view illustrating a configuration of a cell used for a battery pack of a first embodiment of the present invention.

FIGS. 2(a) and 2(b) are views illustrating a configuration of a battery block provided in the battery pack of the first embodiment of the present invention. FIG. 2(a) is a perspective view. FIG. 2(b) is a cross-sectional view along an IIb-IIb line illustrated in FIG. 2(a).

FIGS. 3(a) and 3(b) are views illustrating a configuration of the battery pack of the first embodiment of the present invention. FIG. 3(a) is a perspective view. FIG. 3(b) is a plan view in a second direction.

FIG. 4 is a perspective view illustrating a configuration of a bus bar provided in the battery pack of the first embodiment of the present invention.

FIG. 5 is a perspective view illustrating a configuration of a battery pack of another example of the first embodiment of the present invention.

FIG. 6 is a perspective view illustrating a configuration of a battery pack of a first variation of the first embodiment of the present invention.

FIG. 7 is a perspective view illustrating a configuration of a bus bar provided in the battery pack of the first variation of the first embodiment of the present invention.

FIGS. 8(a) and 8(b) are views illustrating a configuration of a battery pack of a second variation of the first embodiment of the present invention. FIG. 8(a) is a perspective view. FIG. 8(b) is a plan view in a second direction.

FIG. 9 is a perspective view illustrating a configuration of a bus bar provided in the battery pack of the second variation of the first embodiment of the present invention.

FIGS. 10(a) and 10(b) are views illustrating a configuration of a battery pack of a third variation of the first embodiment of the present invention. FIG. 10(a) is a perspective view. FIG. 10(b) is a cross-sectional view along an Xb-Xb line illustrated in FIG. 10(a).

FIG. 11 is a perspective view illustrating a configuration of a bus bar provided in the battery pack of the third variation of the first embodiment of the present invention.

FIG. 12 is a cross-sectional view illustrating a configuration of a battery pack of another variation of the first embodiment of the present invention.

FIG. 13 is a perspective view illustrating a configuration of a bus bar provided in the battery pack of the another variation of the first embodiment of the present invention.

FIG. 14 is a perspective view illustrating a configuration of a bus bar provided in a battery pack of another example of the first embodiment of the present invention.

FIG. 15 is a perspective view illustrating a configuration of a battery pack of a second embodiment of the present invention.

FIG. 16 is a perspective view illustrating a configuration of a bus bar provided in the battery pack of the second embodiment of the present invention.

FIG. 17 is a perspective view illustrating a configuration of a bus bar provided in a battery pack of another example of the second embodiment of the present invention.

FIG. 18 is a perspective view illustrating a configuration of a holder.

FIG. 19 is a perspective view illustrating a configuration of a battery pack.

FIG. 20 is a perspective view illustrating a configuration of a battery pack described in Patent Document 1.

FIG. 21 is a perspective view illustrating a configuration of a unit battery block provided in the battery pack described in Patent Document 1.

FIGS. 22(a) and 22(b) are plan views illustrating a configuration of holder members forming a battery holder provided in the unit battery block.

### DESCRIPTION OF EMBODIMENTS

Embodiments of the present invention will be described below with reference to drawings. Note that each of the following embodiments will be set forth merely for purposes of preferred examples in nature, and the present invention is not limited to the following embodiments. Various modifications or changes may be made without departing from the sprit and scope of the invention, and fall within the scope of the invention. Any relative dimensions of components as shown in the drawings are simply for clarity of illustration, and should not be interpreted as a limitation on the relative dimensions of actual physical elements.

### First Embodiment

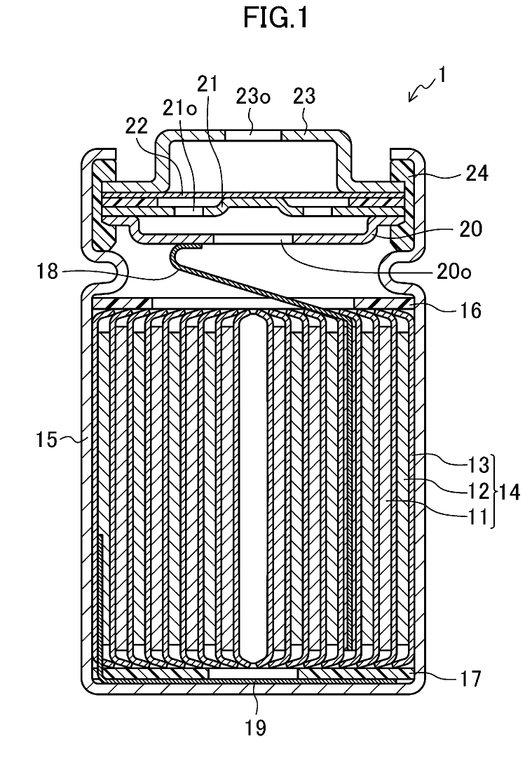

A battery pack of a first embodiment of the present invention will be described below with reference to FIGS. 1, 2, 3(a), 3(b), and 4.

Cell

FIG. 1 is a cross-sectional view illustrating a configuration of a cell used for the battery pack of the present embodiment.

As illustrated in FIG. 1, a cell 1 is, e.g., a cylindrical lithium ion secondary battery. The lithium ion secondary battery used as a power source for mobile electronic devices such as laptop computers, i.e., a high-performance general-purpose battery, is used as the cell 1, thereby improving the performance of a battery block including a plurality of cells and reducing the cost of the battery block.

As illustrated in FIG. 1, an electrode group 14 formed by winding a positive electrode 11 and a negative electrode 12 with a separator 13 being interposed between the positive electrode 11 and the negative electrode 12 is accommodated in a battery case 15 together with a nonaqueous electrolyte solution. Insulators 16 and 17 are arranged respectively at upper and lower ends of the electrode group 14. The positive electrode 11 is connected to a filter 20 electrically connected to a terminal plate 23 serving as a positive electrode terminal, through a positive electrode lead 18. The negative electrode 12 is connected to a bottom part of the battery case 15 serving as a negative electrode terminal, through a negative electrode lead 19.

The filter 20 is connected to an inner cap 21. A protrusion of the inner cap 21 is connected to a metal valve plate 22. The valve plate 22 is connected to the terminal plate 23. As in the foregoing, the terminal plate 23, the valve plate 22, the inner cap 21, and the filter 20 are integrally formed. The terminal plate 23, the valve plate 22, the inner cap 21, and the filter 20 which are integrally formed close an opening of the battery case 15 through a gasket 24.

The cell 1 includes a safety mechanism for discharging gas generated inside the cell 1 to outside the cell 1. Specifically, when, e.g., an internal short occurs in the cell 1, gas is generated inside the cell 1, and the pressure inside the cell 1 is increased. Then, the valve plate 22 warps toward the terminal plate 23. This causes disconnection between the protrusion of the inner cap 21 and the valve plate 22, resulting in interruption of a current path. When the pressure inside the cell 1 is further increased, the valve plate 22 is ruptured. In the foregoing manner, gas generated inside the cell 1 is discharged to outside the cell 1 through an opening 20o of the filter 20, an opening 210 of the inner cap 21, the ruptured part of the valve plate 22, and an opening 23o of the terminal plate 23. Note that the safety mechanism for discharging gas generated inside the cell 1 to outside the cell 1 is not limited to the structure illustrated in FIG. 1, and other structures may be employed.

In the present embodiment, the case where the lithium ion secondary battery is used as the cell has been described as a specific example, but the present invention is not limited to such a case.

In the present embodiment, the case where the cylindrical battery is used as the cell has been described as a specific example, but the present invention is not limited to such a case. For example, an angular battery may be used.

Battery Block

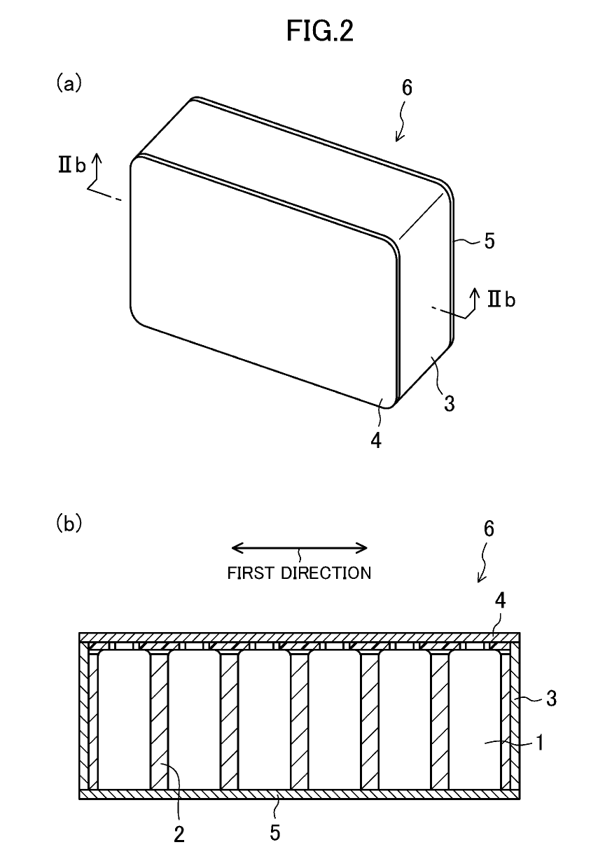

FIGS. 2(a) and 2(b) are views illustrating a configuration of the battery block provided in the battery pack of the present embodiment. FIG. 2(a) is a perspective view, and FIG. 2(b) is a cross-sectional view along an IIb-IIb line illustrated in FIG. 2(a).

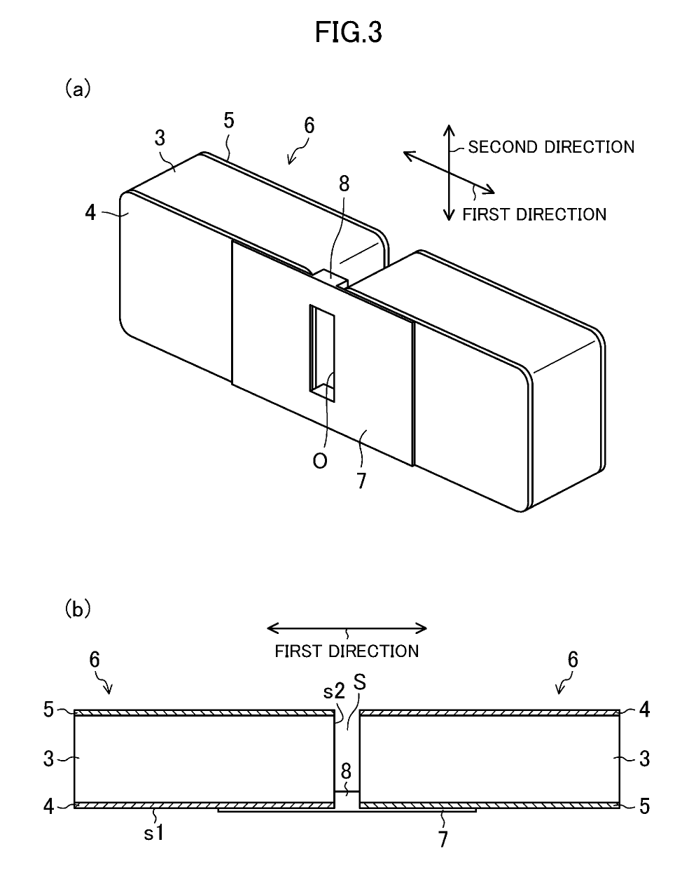

As illustrated in FIGS. 3(a) and 3(b) which will be described later, a plurality of battery blocks 6 provided in the battery pack of the present embodiment are arranged adjacent to each other in a first direction. The first direction is a direction in which the electrically-connected battery blocks 6 are arranged as illustrated in FIGS. 3(a) and 3(b).

As illustrated in FIGS. 2(a) and 2(b), the battery block 6 includes a plurality of cells 1, a holder 2 having accommodation parts in each of which the cell 1 is accommodated, a case 3 in which the holder 2 is accommodated, a positive electrode current collector plate 4 arranged at ends of the plurality of cells 1 on one side thereof (on a side closer to the positive electrode terminal), and a negative electrode current collector plate 5 arranged at ends of the plurality of cells 1 on the other side thereof (on a side closer to the negative electrode terminal).

The positive electrode current collector plate 4 electrically connects the positive electrode terminals of the cells 1 in parallel. On the other hand, the negative electrode current collector plate 5 electrically connects the negative electrode terminals of the cells 1 in parallel.

A plurality of through-holes penetrating the holder 2 are formed in the holder 2, and the cell 1 is inserted into each of the through-holes. In other words, the holder 2 has the plurality of accommodation parts (i.e., parts around the through-holes), and the cell 1 is accommodated in each of the accommodation parts.

An inner surface of the accommodation part is in such a shape that the inner surface of the accommodation part can contact an outer surface of the cell 1. If the cell 1 is, e.g., a cylindrical battery, the inner surface of the accommodation part is in a cylindrical shape, and the outer surface of the cell 1 contacts the inner surface of the accommodation part.

The holder 2 is made of, e.g., a thermally conductive material. Specifically, the holder 2 may be made of, e.g., aluminum (Al), copper (Cu), or resin to which an aluminum oxide, an titanium oxide, or an aluminum nitride is added.

Battery Pack

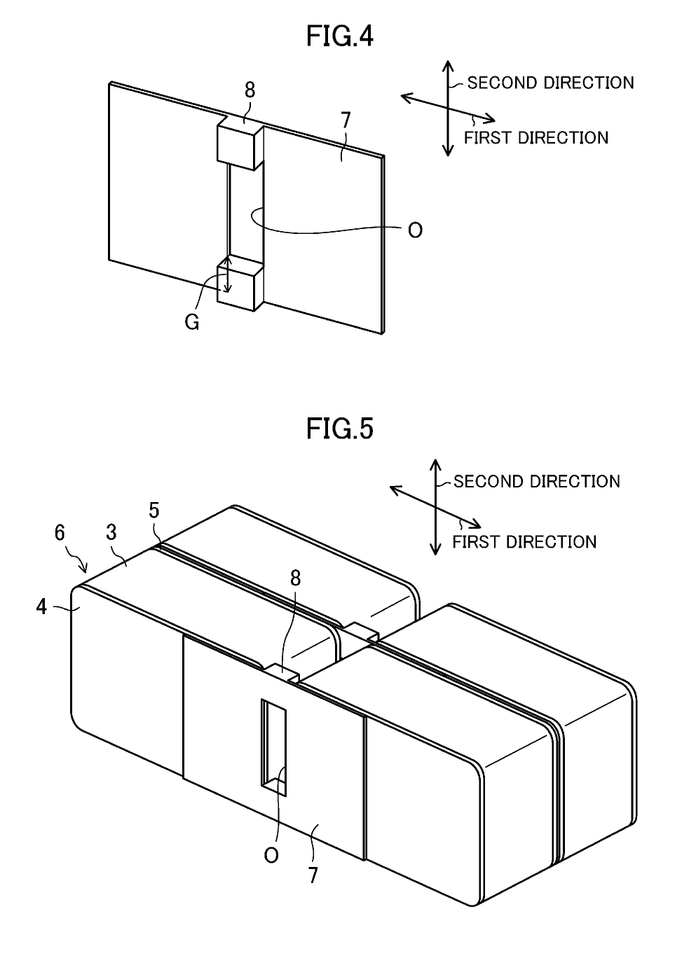

FIGS. 3(a) and 3(b) are views illustrating a configuration of the battery pack of the present embodiment. FIG. 3(a) is a perspective view, and FIG. 3(b) is a plan view in a second direction. The second direction is a direction perpendicular to a first direction as illustrated in FIG. 3(a). FIG. 4 is a perspective view illustrating a configuration of a bus bar provided in the battery pack of the present embodiment.

As illustrated in FIGS. 3(a) and 3(b), the battery pack of the present embodiment includes a plurality of battery blocks 6 arranged adjacent to each other in the first direction with a predetermined space S (see, in particular, FIG. 3(b)), and a flat plate shaped bus bar 7 arranged so as to contact first surfaces s1 of the adjacent battery blocks 6 and electrically and physically connecting the adjacent battery blocks 6.

An opening O (see, in particular, FIG. 3(a)) communicating with the space S is formed in the bus bar 7. The opening O and the space S form a flow path through which cold air or warm air flows. The cells 1 accommodated in the battery blocks 6 can be cooled by cold air flowing through the flow path. On the other hand, the cells 1 accommodated in the battery blocks 6 can be warmed by warm air flowing through the flow path.

The bus bar 7 includes first raised parts 8 each protruding toward the space S. Each of the first raised parts 8 contacts second surfaces s2 (see, in particular, FIG. 3(b)) of the adjacent battery blocks 6 exposed in the space S.

As illustrated in FIG. 4, the opening O extends in the second direction. The bus bar 7 includes a plurality of first raised parts 8 (e.g., two first raised parts 8), and the plurality of first raised parts 8 are positioned respectively at both ends of the opening O in the second direction. Each of the first raised parts 8 preferably extends from one end of the opening O in the second direction to one end of the bus bar 7 in the second direction.

As illustrated in FIG. 3(b), each of the first raised parts 8 is in, e.g., a rectangular planar shape as viewed in the second direction. In other words, the first raised part 8 is in such a shape that the width of the first raised part 8 in the first direction is, e.g., constant in a direction toward a tip end of the first raised part 8.

As illustrated in FIG. 3(b), the width of the space S in the first direction is the same as the width of the first raised part 8 in the first direction. As illustrated in FIG. 4, the width of the opening O in the first direction is, e.g., the same as the width of the first raised part 8 in the first direction (i.e., the width of the space S in the first direction).

As illustrated in FIG. 3(b), the bus bar 7 electrically connects the positive electrode current collector plate 4 of the battery block 6 illustrated on the left side and the negative electrode current collector plate 5 of the battery block 6 illustrated on the right side together. Thus, the first surface s1 of the battery block 6 illustrated on the left side is a surface of the positive electrode current collector plate 4. On the other hand, the first surface s1 of the battery block 6 illustrated on the right side is a surface of the negative electrode current collector plate 5.

Current flows from the positive electrode current collector plate 4 to the negative electrode current collector plate 5 through the bus bar 7.

The bus bar 7 is made of a conductive material. The bus bar 7 contains at least one of, e.g., copper (Cu), aluminum (Al), nickel (Ni), silver (Ag), or gold (Au).

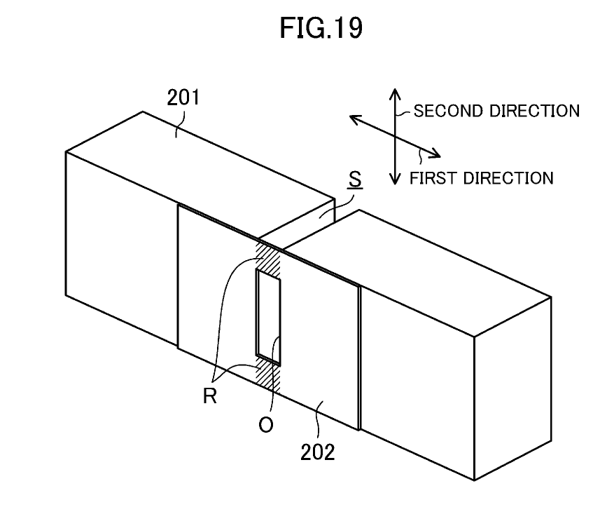

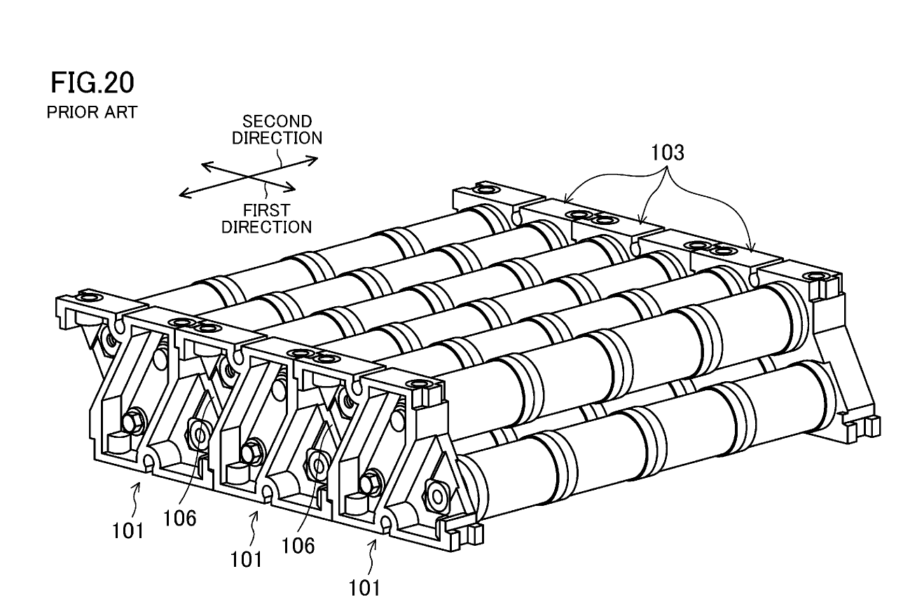

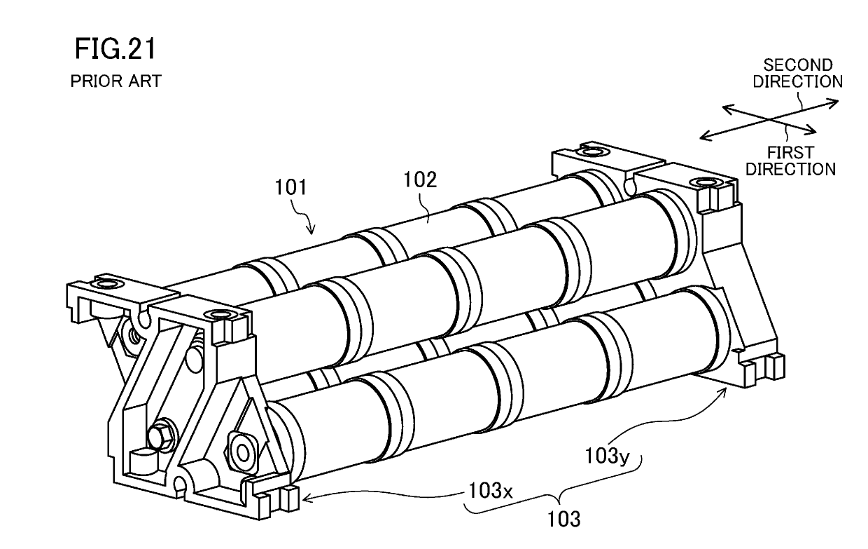

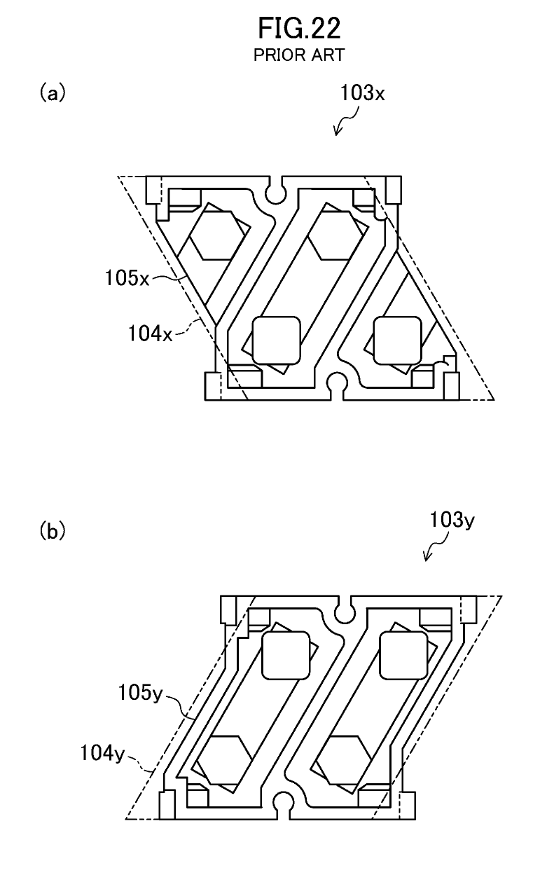

According to the present embodiment, the first raised parts 8 are provided so as to be positioned respectively at both ends of the opening O in the second direction. Thus, the first raised parts 8 can be provided respectively in regions (see the current concentration regions R of FIG. 19) of the bus bar 7 at the sides of the opening O in the second direction. This increases a cross-sectional area of each of the foregoing regions, thereby preventing current concentration on the foregoing regions. Consequently, the following can be prevented: electric resistance in each of the foregoing regions is increased due to the current concentration, and a voltage drop occurs in each of the foregoing regions. In addition, it can be prevented that heat is generated in each of the foregoing regions due to the current concentration.

Each of the first raised parts 8 contacts the second surfaces s2 of the adjacent battery blocks 6. This determines the positions of the adjacent battery blocks 6 and the width of the space S in the first direction.

The first raised parts 8 are provided so as to be positioned respectively at both ends of the opening O in the second direction. Thus, the first raised parts 8 can be provided in part of a region of the bus bar 7 around the opening O. This increases the cross-sectional area of such a part, thereby enhancing the strength of such a part. Consequently, even if the battery block 6 receives, e.g., impact force, and stress is generated at part of the bus bar 7 contacting the first surface s1 of the battery block 6 which has received the impact force, bending or cutting of the bus bar 7 in the region thereof around the opening O can be prevented.

Each of the first raised parts 8 contacts the second surfaces s2 of the adjacent battery blocks 6. Thus, even if the battery block 6 receives force in the first direction, movement of the battery blocks 6 in the first direction (i.e., in a direction in which the force is applied) can be prevented. Consequently, the bending or cutting of the bus bar 7 in the region thereof around the opening O can be further prevented.

In the present embodiment, the case where the number of the battery blocks 6 provided in the battery pack of the present embodiment is two has been described as a specific example for the sake of easy understanding. However, the present invention is not limited to such a case. The battery pack may actually include more battery blocks. As will be seen from FIG. 5, if the battery pack includes, e.g., four battery blocks, it is likely that heat is trapped in a center part of the battery pack. Thus, it is necessary that, e.g., cold air is introduced into flow paths formed by openings and spaces to cool cells accommodated in the battery blocks.

As illustrated in FIGS. 3(a) and 4, in the present embodiment, the case where the flat plate shaped bus bar 7 including the first raised parts 8 is in a rectangular shape has been described as a specific example. However, the present invention is not limited to such a case. The bus bar may be in any shapes as long as the adjacent battery blocks can be electrically and physically connected together.

As illustrated in FIG. 4, in the present embodiment, the case where the first raised part 8 extends from one end of the opening O in the second direction to one end of the bus bar 7 in the second direction, i.e., the case where each of the first raised parts 8 is formed across the entirety of the current concentration region (see the current concentration region R of FIG. 19) has been described as a specific example. However, the present invention is not limited to such a case.

The first raised part may be formed in at least part of the current concentration region. In order to compensate for part of the bus bar through which current is supposed to flow and which is removed for the purpose of providing the opening, the first raised part may be formed in at least part of the region of the bus bar 7 where current flows around the opening. Thus, the current flowing around the opening can flow through the first raised part, thereby preventing the current concentration on the current concentration region.

### First Variation of First Embodiment

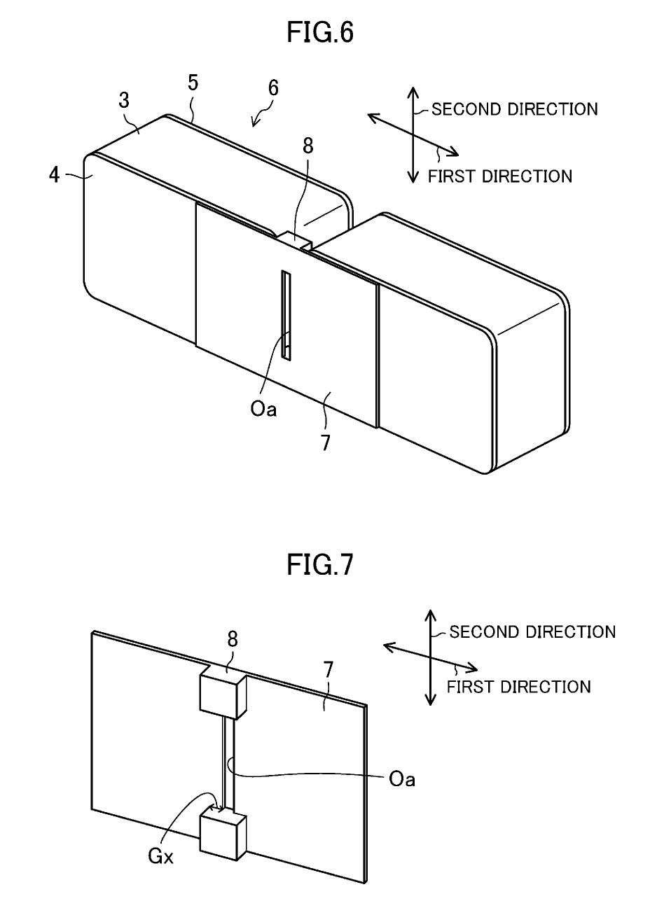

A battery pack of a first variation of the first embodiment of the present invention will be described below with reference to FIGS. 6 and 7. FIG. 6 is a perspective view illustrating a configuration of the battery pack of the present variation. FIG. 7 is a perspective view illustrating a configuration of a bus bar provided in the battery pack of the present variation. Note that the same reference numerals as those shown in the first embodiment are used to represent equivalent elements in FIGS. 6 and 7. Thus, in the present variation, the description of such elements is not repeated.

Differences between the present variation and the first embodiment are as follows.

As illustrated in FIG. 7, in the present variation, the width of an opening Oa in a first direction is smaller than the width of a first raised part 8 in the first direction (i.e., the width of a space in the first direction).

On the other hand, as illustrated in FIG. 4, in the first embodiment, the width of the opening O in the first direction is the same as the width of the first raised part 8 in the first direction (i.e., the width of the space S in the first direction).

According to the present variation, the advantages similar to those of the first embodiment can be realized. In addition, the following advantage can be further realized.

In the first embodiment, a current inlet G of the first raised part 8 is relatively narrow as illustrated in FIG. 4. Thus, there is a possibility that a temperature at a corner of the battery block 6 positioned near the current inlet G is increased due to current concentratedly flowing into the first raised part 8 through the current inlet G.

Thus, in the present variation, the width of the first raised part 8 in the first direction is larger than the width of the opening Oa in the first direction. Thus, another current inlet Gx of the first raised part 8 can be formed as illustrated in FIG. 7. This prevents the increase in temperature at the corner of the battery block 6.

### Second Variation of First Embodiment

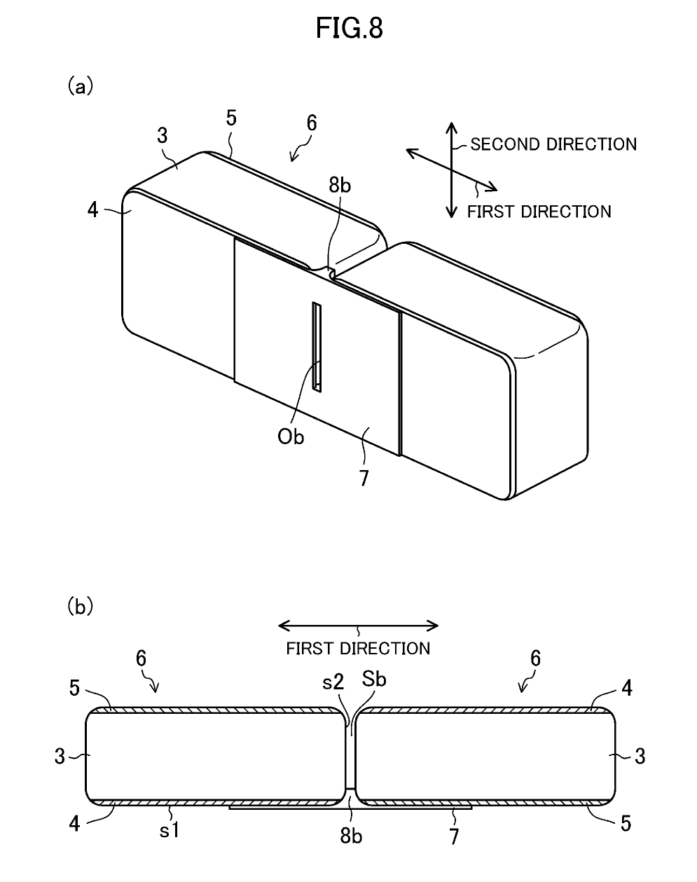

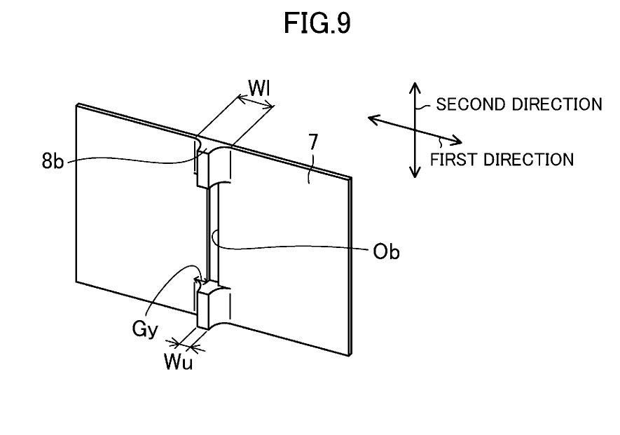

A battery pack of a second variation of the first embodiment of the present invention will be described below with reference to FIGS. 8(a), 8(b), and 9. FIGS. 8(a) and 8(b) are views illustrating a configuration of the battery pack of the present variation. FIG. 8(a) is a perspective view, and FIG. 8(b) is a plan view in a second direction. FIG. 9 is a perspective view illustrating a configuration of a bus bar provided in the battery pack of the present variation. Note that the same reference numerals as those shown in the first embodiment are used to represent equivalent elements in FIGS. 8(a), 8(b) and 9. Thus, in the present variation, the description of such elements is not repeated.

Differences between the present variation and the first embodiment are as follows.

As illustrated in FIGS. 8(a) and 8(b), in the present variation, each of end parts of a second surface s2 of a battery block 6 is a curved part. Each of first raised parts 8b contacts the curved parts, and each of side surfaces of the first raised parts 8b in a first direction is a curved surface fitted onto the curved part. The first raised part 8b is in such a shape that the width of the first raised part 8b in the first direction is decreased toward a tip end thereof.

On the other hand, in the first embodiment, the second surface s2 of the battery block 6 is perpendicular to a surface of the flat plate shaped bus bar 7 as illustrated in FIGS. 3(a) and 3(b). Each of side surfaces of the first raised parts 8 in the first direction contacts an end part of the second surface s2 so as to be perpendicular to the surface of the flat plate shaped bus bar 7. The first raised part 8 is in such a shape that the width of the first raised part 8 in the first direction is constant in the direction toward the tip end thereof.

As illustrated in FIG. 9, in the present variation, a width Wu of the tip end (upper end) of the first raised part 8b in the first direction is smaller than a width W1 of a lower end of the first raised part 8b in the first direction. As illustrated in FIGS. 8(b) and 9, the width Wu of the upper end of the first raised part 8b in the first direction is the same as the width (see, in particular, FIG. 8(b)) of a space Sb in the first direction and the width (see, in particular, FIG. 9) of an opening Ob in the first direction.

On the other hand, in the first embodiment, the width of an upper end of the first raised part 8 in the first direction is the same as the width of a lower end of the first raised part 8 in the first direction as illustrated in FIG. 4. As illustrated in FIGS. 3(b) and 4, the width of the upper end of the first raised part 8 in the first direction and the width of the lower end of the first raised part 8 in the first direction are the same as the width (see, in particular, FIG. 3(b)) of the space S in the first direction and the width (see, in particular, FIG. 4) of the opening O in the first direction.

According to the present variation, the advantages similar to those of the first embodiment can be realized.

In addition, the advantages similar to those of the first variation of the first embodiment can be realized.

Specifically, in the present variation, each of the end parts of the second surface s2 of the battery block 6 is the curved part. In addition, the width Wu of the upper end of the first raised part 8b contacting the curved part in the first direction is the same as the width of the opening Ob in the first direction, and the width W1 of the lower end of the first raised part 8b in the first direction is larger than the width of the opening Ob in the first direction. Thus, as illustrated in FIG. 9, another current inlet Gy of the first raised part 8b can be formed. This prevents an increase in temperature at a corner of the battery block 6.

### Third Variation of First Embodiment

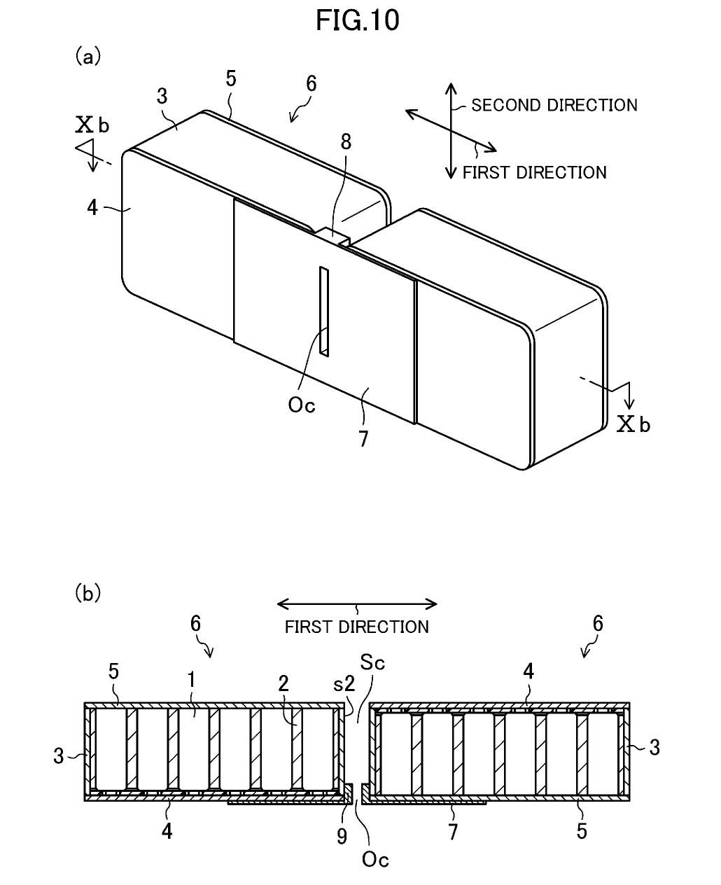

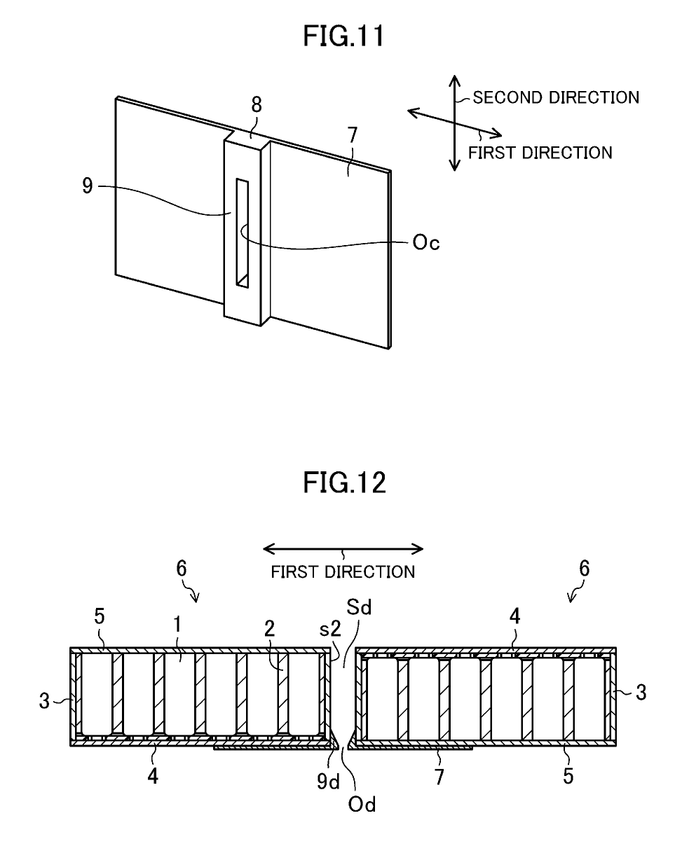

A battery pack of a third variation of the first embodiment of the present invention will be described below with reference to FIGS. 10(a), 10(b), and 11. FIGS. 10(a) and 10(b) are views illustrating a configuration of the battery pack of the present variation. FIG. 10(a) is a perspective view, and FIG. 10(b) is a cross-sectional view along an Xb-Xb line illustrated in FIG. 10(a). FIG. 11 is a perspective view illustrating a configuration of a bus bar provided in the battery pack of the present variation. Note that the same reference numerals as those shown in the first embodiment are used to represent equivalent elements in FIGS. 10(a), 10(b) and 11. Thus, in the present variation, the description of such elements is not repeated.

Differences between the present variation and the first embodiment are as follows.

As illustrated in FIG. 11, in the present variation, a flat plate shaped bus bar 7 includes a pair of first raised parts 8 and a pair of second raised parts 9. The width of an opening Oc in a first direction is smaller than the width of the first raised part 8 in the first direction (i.e., the width of a space Sc in the first direction).

On the other hand, in the first embodiment, the flat plate shaped bus bar 7 includes only the pair of first raised parts 8 as illustrated in FIG. 4. The width of the opening O in the first direction is the same as the width of the first raised part 8 in the first direction (i.e., the width of the space S in the first direction).

As illustrated in FIG. 11, the second raised parts 9 are positioned respectively at both ends of the opening Oc in the first direction. As illustrated in FIG. 10(b), each of the second raised parts 9 protrudes toward the space Sc.

As illustrated in FIG. 11, end parts of the second raised parts 9 in a second direction contact, on one side, one of the first raised parts 8. On the other hand, end parts of the second raised parts 9 contact, on the other side, the other first raised part 8.

As illustrated in FIG. 11, a side surface of the first raised part 8 in the first direction is flush with a side surface of the second raised part 9 in the first direction. As will be seen from FIG. 10(a), both side surfaces of the first raised part 8 in the first direction contact second surfaces s2 of adjacent battery blocks 6, respectively. As illustrated in FIG. 10(b), the side surface of the second raised part 9 in the first direction contacts the second surface s2 of the battery block 6.

According to the present variation, the first raised part 8 can be, as in the first embodiment, provided in each of regions (see the current concentration regions R of FIG. 19) of the bus bar 7 at the sides of the opening Oc in the second direction. This increases a cross-sectional area of each of the regions, thereby preventing current concentration on such regions.

In addition, the second raised part 9 improves the advantages of the first embodiment as follows.

Not only the first raised parts 8 but also the second raised parts 9 positioned respectively at both ends of the opening Oc in the first direction are provided. This further increases a cross-sectional area of a region of the bus bar 7 around the opening Oc as compared to the first embodiment, thereby further increasing the strength of such a region. Thus, bending or cutting of the bus bar 7 in the region thereof around the opening Oc can be further prevented.

Not only the first raised parts 8 but also the second raised parts 9 respectively contacting the second surfaces s2 of the adjacent battery blocks 6 are provided. This further prevents movement of the battery blocks 6 in the first direction.

The second raised parts 9 positioned respectively at both ends of the opening Oc in the first direction prevent current concentration on the regions of the bus bar 7 at the sides of the opening Oc in the first direction.

Each of the second raised parts 9 contacting the first raised parts 8 allows current to flow from the second raised part 9 to the first raised part 8, and therefore current is likely to flow through the first raised part 8.

As illustrated in FIG. 11, in the present variation, the case where the end parts of the second raised parts 9 in the second direction contact the first raised part 8 has been described as a specific example, but the present invention is not limited to such a case.

As illustrated in FIG. 11, in the present variation, the case where the side surface of the second raised part 9 in the first direction is flush with the side surface of the first raised part 8 in the first direction has been described as a specific example, but the present invention is not limited to such a case. For example, the side surface of the second raised part in the first direction may be positioned on an inner side (on a side closer to the opening) relative to the side surface of the first raised part in the first direction. Note that, if the side surface of the second raised part 9 in the first direction is flush with the side surface of the first raised part 8 in the first direction as in the present variation, the movement of the battery blocks 6 in the first direction can be further prevented as described above.

As illustrated in FIGS. 10(b) and 11, in the present variation, the case where the second raised part 9 is in such a shape that the width of the second raised part 9 in the first direction is constant in a direction toward a tip end thereof has been described as a specific example, but the present invention is not limited to such a case.

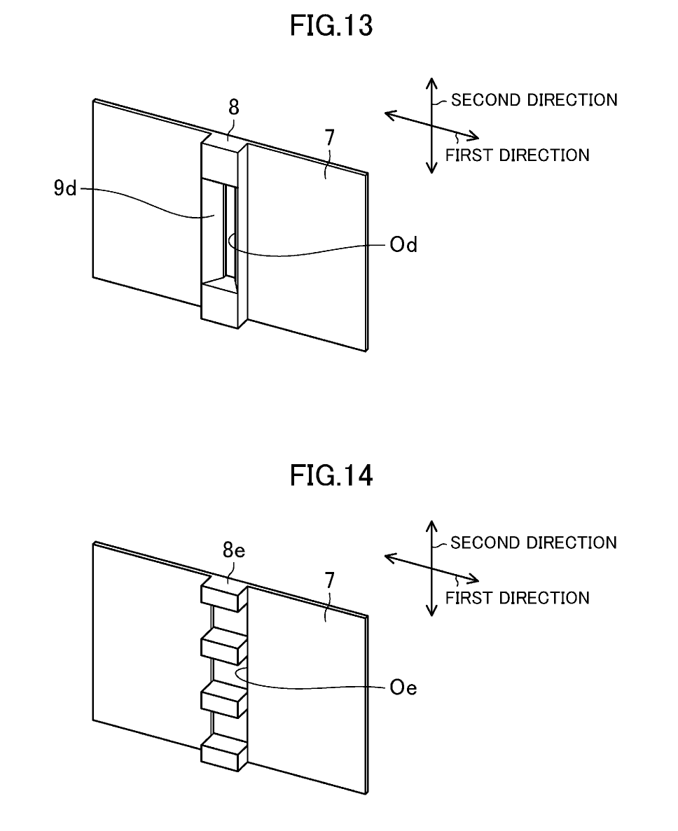

For example, as illustrated in FIGS. 12 and 13, a second raised part 9d may be in such a shape that the width of the second raised part 9d in the first direction is decreased toward a tip end thereof. In other words, as illustrated in FIG. 12, a surface of the second raised part 9d exposed in a space Sd may be a surface inclined from an opening Od to the space Sd.

Cool air or warm air entering the opening Od flows along the inclined surfaces of the second raised parts 9d, and then comes into contact with the second surfaces s2 of the battery blocks 6 in an effective manner. Thus, cells 1 accommodated in the battery blocks 6 can be effectively cooled or warmed.

The case where the number of openings is one has been described as a specific example in the first embodiment and the first to third variations thereof, but the present invention is not limited to such a case.

For example, as illustrated in FIG. 14, the number of openings may be a plural number (e.g., three). A plurality of openings Oe are arranged in a second direction (vertical direction in the plane of paper of FIG. 14). In such a case, a first raised part 8e is positioned between adjacent ones of the openings Oe, another first raised part 8e is positioned at an upper end of the uppermost opening Oe, and still another first raised part 8e is positioned at a lower end of the lowermost opening Oe.

As described above, the number of first raised parts 8e can be increased, e.g., from two to four as compared to the first embodiment. Thus, the advantages of the first embodiment can be improved as follows.

As compared to the first embodiment, the number of first raised parts 8e to be provided respectively in current concentration regions (i.e., regions of a bus bar 7, each of which is at the side of each of the plurality of openings Oe in the second direction) can be increased. This further increases a cross-sectional area of each of such regions, thereby further preventing current concentration on such regions.

As compared to the first embodiment, the number of first raised parts 8e to be provided respectively in low strength regions (i.e., regions of the bus bar 7, each of which is around each of the plurality of openings Oe) can be increased. This further increases a cross-sectional area of each of such regions, thereby further enhancing the strength of such regions. Thus, bending or cutting of the bus bar 7 in the region of the bus bar 7 around each of the plurality of openings Oe can be further prevented.

As compared to the first embodiment, the number of first raised parts 8e which will contact the second surfaces of the adjacent battery blocks 6 can be increased. This further prevents movement of the battery blocks 6 in a first direction.

### Second Embodiment

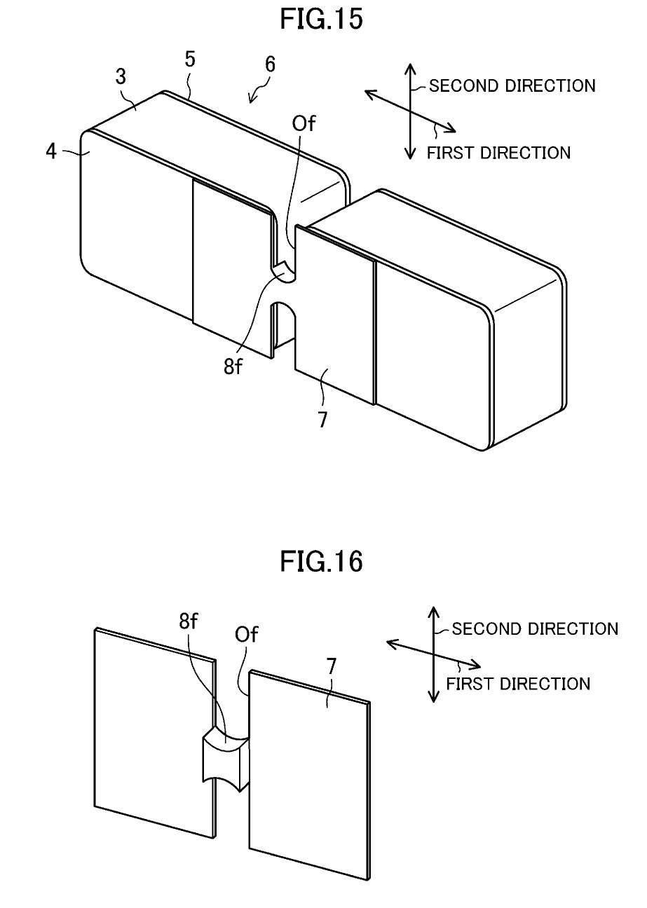

A battery pack of a second embodiment of the present invention will be described below with reference to FIGS. 15 and 16. FIG. 15 is a perspective view illustrating a configuration of the battery pack of the present embodiment. FIG. 16 is a perspective view illustrating a configuration of a bus bar provided in the battery pack of the present embodiment. Note that the same reference numerals as those shown in the first embodiment are used to represent equivalent elements in FIGS. 15 and 16. Thus, in the present embodiment, the description of such elements is not repeated.

Differences between the present embodiment and the first embodiment are as follows.

As illustrated in FIG. 16, in the present embodiment, a plurality of openings Of (e.g., two openings Of) are formed in a bus bar 7. One of the plurality of openings Of is a cut part of the bus bar 7 extending from one end to the center of the bus bar 7 in a second direction. The other opening Of is a cut part of the bus bar 7 extending from the other end to the center of the bus bar 7 in the second direction. A first raised part 8f is positioned between the openings Of adjacent to each other in the second direction.

On the other hand, in the first embodiment, e.g., the single opening O is formed in the bus bar 7 as illustrated in FIG. 4. The opening O is a slit part extending in the second direction. The first raised parts 8 are positioned respectively at both ends of the opening O in the second direction.

According to the present embodiment, the advantages similar to those of the first embodiment can be realized.

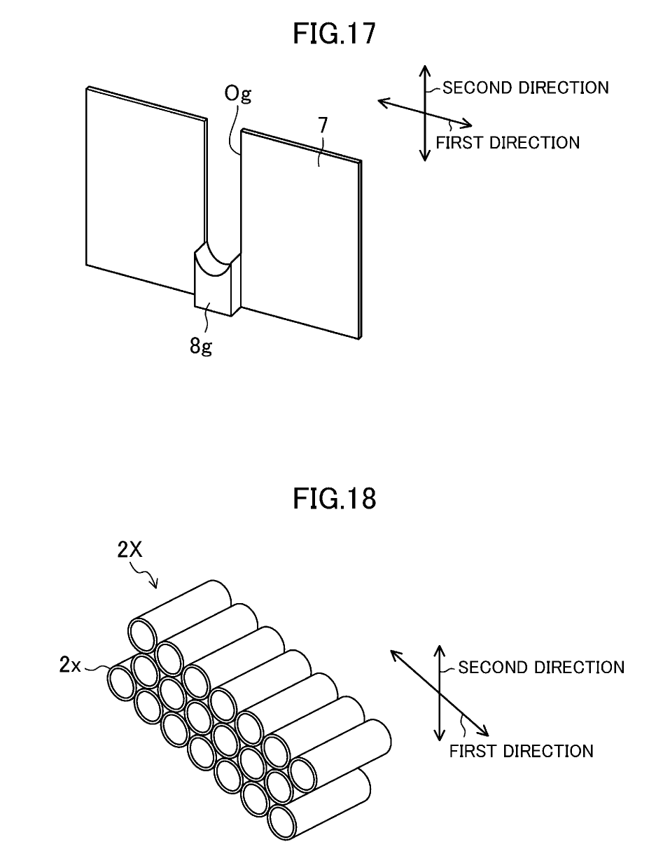

As illustrated in FIG. 16, in the present embodiment, the case where the two openings Of (cut parts) each extending from the end to the center of the bus bar 7 in the second direction are formed has been described as a specific example, but the present invention is not limited to such a case. For example, as illustrated in FIG. 17, a single opening Og (cut part) extending from one end to the other end of the bus bar 7 in the second direction may be formed. In such a case, a first raised part 8g is positioned at one end of the opening Og in the second direction.

In the second embodiment, the case where the width of the first raised part 8f in a first direction is the same as the width of the opening Of in the first direction has been described as a specific example, but the present invention is not limited to such a case. For example, as in the first variation of the first embodiment, the width of the first raised part in the first direction may be larger than the width of the opening in the first direction. This realizes the advantages similar to those of the first variation of the first embodiment.

In the second embodiment, the case where a second surface of a battery block 6 is perpendicular to a surface of the flat plate shaped bus bar 7, and the width of an upper end of the first raised part 8f in the first direction and the width of a lower end of the first raised part 8f in the first direction are the same as the width of the opening Of in the first direction has been described as a specific example, but the present invention is not limited to such a case. For example, as in the second variation of the first embodiment, each of end parts of the second surface of the battery block may be a curved part. In addition, the width of the upper end of the first raised part in the first direction may be the same as the width of the opening in the first direction, and the width of the lower end of the first raised part in the first direction may be larger than the width of the opening in the first direction. This realizes the advantages similar to those of the second variation of the first embodiment.

In the second embodiment, the case where only the first raised part 8f is provided has been described as a specific example, but the present invention is not limited to such a case. For example, as in the third variation of the first embodiment, second raised parts positioned respectively at both ends of the opening in the first direction may be provided. This realizes the advantages similar to those of the third variation of the first embodiment.

As illustrated in FIG. 2, in the first embodiment, the first to third variations of the first embodiment, and the second embodiment, the case where the holder 2 is accommodated in the insulating case 3 has been described as a specific example, but the present invention is not limited to such a case. The holder is not necessarily accommodated in the case. In the case where the holder is accommodated in the case, even if adjacent ones of the battery blocks arranged in the first direction contact each other, adjacent ones of the cases arranged in the first direction are merely in contact with each other, and adjacent ones of the holders arranged in the first direction are not electrically connected together. However, in the present invention, since the first raised part can prevent the movement of the battery blocks in the first direction, there is little possibility of contacting adjacent ones of the battery blocks arranged in the first direction.

As illustrated in FIG. 2, in the first embodiment, the first to third variations of the first embodiment, and the second embodiment, the case where the holder 2 having the plurality of through-holes is used as the holder has been described as a specific example, but the present invention is not limited to such a case. For example, as illustrated in FIG. 18, a holder 2X including a plurality of hollow cylindrical pipes (accommodation parts) 2x may be used. Adjacent ones of the pipes 2x are jointed together.

As illustrated in FIG. 3, in the first embodiment, the first to third variations of the first embodiment, and the second embodiment, the case where the battery pack including the plurality of battery blocks 6 in each of which the plurality of cells (see the cells 1 illustrated in FIG. 2(b)) are accommodated and the bus bar 7 electrically connecting the adjacent battery blocks 6 together is used has been described as a specific example, but the present invention is not limited to such a case. For example, a battery may be used instead of the battery block 6 in which the plurality of cells 1 are accommodated, and a battery pack including a plurality of batteries and a bus bar electrically connecting the adjacent batteries together may be used. In such a case, the plurality of batteries are arranged adjacent to each other in the first direction with a predetermined space as in the first embodiment, the first to third variations of the first embodiment, and the second embodiment. At least one opening communicating with the space is formed in the bus bar. The bus bar includes at least one first raised part arranged so as to contact first surfaces of the adjacent batteries and protruding toward the space. The first raised part contacts second surfaces of the adjacent batteries exposed in the space.

### INDUSTRIAL APPLICABILITY

In the present invention, the current concentration on the particular region of the bus bar can be prevented, and the bending or cutting of the bus bar can be prevented. Thus, the present invention is useful as the battery pack including the bus bar electrically connecting adjacent ones of the battery blocks together.

### DESCRIPTION OF REFERENCE CHARACTERS

1 Cell
2, 2X Holder
2x Pipe
3 Case
4 Positive Electrode Current Collector Plate
5 Negative Electrode Current Collector Plate
6 Battery Block
7 Bus Bar
8, 8b, 8e, 8f, 8g First Raised Part
9, 9d Second Raised Part
O, Oa, Ob, Oc, Od, Oe, Of, Og Opening
S, Sb, Sc, Sd Space
s1 First Surface
s2 Second Surface
G, Gx, Gy Current Inlet
Wu, W1 Width
11 Positive Electrode
12 Negative Electrode
13 Separator
14 Electrode Group
15 Battery Case
16, 17 Insulator
18 Positive Electrode Lead
19 Negative Electrode Lead
20 Filter
21 Inner Cap
22 Valve Plate
23 Terminal Plate
24 Gasket
20o, 21o, 23o Opening

1. A battery pack, comprising:
a plurality of battery blocks in each of which a plurality of cells are accommodated and which are arranged adjacent to each other in a first direction with a predetermined space; and
a flat plate shaped bus bar arranged so as to contact first surfaces of adjacent ones of the battery blocks and electrically connecting adjacent ones of the battery blocks together,
wherein at least one opening communicating with the space is formed in the bus bar,
the bus bar includes at least one first raised part protruding toward the space, and
the first raised part contacts second surfaces of adjacent ones of the battery blocks exposed in the space.

2. The battery pack of claim 1, wherein
the first raised part is positioned at at least one end of the opening in a second direction perpendicular to the first direction.

3. The battery pack of claim 1, wherein
a width of the opening in the first direction is identical to a width of the space in the first direction.

4. The battery pack of claim 1, wherein
a width of the opening in the first direction is smaller than a width of the space in the first direction.

5. The battery pack of claim 3, wherein
an end part of the second surface of the battery block is a curved part, and
the first raised part contacts the curved part.

6. The battery pack of claim 1, wherein
the bus bar further includes a pair of second raised parts positioned respectively at both ends of the opening in the first direction and protruding toward the space.

7. The battery pack of claim 6, wherein
the second raised parts contact the second surfaces of the battery blocks, respectively.

8. The battery pack of claim 6, wherein
each of the second raised parts is in such a shape that a width thereof in the first direction is decreased toward a tip end thereof.

9. The battery pack of claim 1, wherein
each of the battery blocks further includes a current collector plate arranged on a side closer to the first surface of the battery block and electrically connecting terminals of the plurality of cells in parallel, and
the bus bar electrically connects the current collector plates of adjacent ones of the battery blocks together.

10. The battery pack of claim 2, wherein
the first raised part extends from one end of the opening in the second direction perpendicular to the first direction to one end of the bus bar in the second direction.

11. The battery pack of claim 1, wherein
the opening is a cut part.

12. The battery pack of claim 1, wherein
the opening includes a plurality of openings, and
the plurality of openings are arranged in a second direction perpendicular to the first direction.

13. A battery pack, comprising:
a plurality of batteries arranged adjacent to each other in a first direction with a predetermined space; and
a flat plate shaped bus bar arranged so as to contact first surfaces of adjacent ones of the batteries and electrically connecting adjacent ones of the batteries together,
wherein at least one opening communicating with the space is formed in the bus bar,
the bus bar includes at least one first raised part protruding toward the space, and
the first raised part contacts second surfaces of adjacent ones of the batteries exposed in the space.

14. The battery pack of claim 13, wherein
the first raised part is positioned at at least one end of the opening in a second direction perpendicular to the first direction.

15. The battery pack of claim 13, wherein
a width of the opening in the first direction is identical to a width of the space in the first direction.

16. The battery pack of claim 13, wherein
a width of the opening in the first direction is smaller than a width of the space in the first direction.

17. The battery pack of claim 15, wherein
an end part of the second surface of the battery is a curved part, and
the first raised part contacts the curved part.
